(19) United States
(12) Patent Application Publication
(10) Pub. No.: US 2002/0156950 A1
(43) Pub. Date: Oct. 24, 2002

(54) Auto-determination of connection type

(76) Inventors: Thiam Wah Loh, Singapore (SG); Khiam Yong Tan, Singapore (SG)

Correspondence Address: HEWLETT-PACKARD COMPANY, Intellectual Property Administration, P.O. Box 272400, Fort Collins, CO, 80527-2400, US

(21) Appl. No.: 09/833,941

(22) Filed: Apr. 12, 2001

(51) Int. Cl. G06F 13/12

(52) U.S. Cl. 710/104

(57) ABSTRACT

A computer-based method is provided for auto-determination of connection type between a Personal Digital Assistant (PDA) and a desktop computer. Current common connection types include serial, USB and infrared. The present invention uses an assertion signal such as a Clear To Send (CTS) signal to distinguish serial connection. With the present invention, the user does not need to set connection type manually. Instead, when the PDA is docked or connected, determination of connection type and synchronization of data follow without user intervention.

### FIELD OF THE INVENTION

The present invention relates to interfacing personal computer systems with portable devices and more particularly to differentiating between connection types.

### BACKGROUND OF THE INVENTION

Small portable devices for electronic computation and personal information management are often and hereinafter referred to as personal digital assistants (PDAs). PDAs are commonly known as handheld personal computers (H/PCs), pocket PCs, personal organizers, palmtop computers and palm-size PCs, or by brand names such as the Jornada sold by Hewlett Packard Company.

These mobile devices can be customized to meet a variety of computational, software and information management demands of users who are on the move. Common applications in a mobile device include electronic mail programs, calendar programs, and the like that are frequently modified. Modifications made in the mobile devices will be saved and updated only in these devices. Most mobile device users would normally have access to desktop computers at office, at home or both. Changes made on the mobile device will not be simultaneously updated on desktop computers and vice versa. Thus, it is desirable that both mobile device and desktop computers contain the most up-to-date information. The process in which the mobile device and the desktop computers interact and update information so that eventually each contains the most up-to-date information is referred to as synchronization.

Synchronization can be via wired or wireless connection. Common wired connection types include serial (9-pin) and Universal Serial Bus (USB). The mobile device can be connected to a personal computer system indirectly through a docking station (commonly known as a “cradle”), or directly to a personal computer system with a serial or USB cable connection. Common wireless connection includes infrared and wireless modem and wireless cellular digital packet data (CPDP).

Depending on the available ports and the operating system of individual desktop computers and PDAs, the connection type may be limited to one of the following: serial, USB or infrared. For example, a desktop PC with Windows NT operating system supports serial connection. A desktop PC with Windows 95 operating system supports serial and infrared connections. A desktop PC with Windows 98 or 2000 operating system supports serial, USB and infrared connections. Many users have existing desktop computers with one of serial, USB or both ports available. Hence, the connection type varies depending on the desktop computer to which the portable device is connected. When a user port a PDA from one desktop computer to another, the connection type may be different.

Users expect a “dock and sync” experience, i.e. synchronization to effect with minimal user intervention. However, many operating systems for PDA cannot differentiate between connection types. Users have to navigate through several steps to set or change the prospective connection type and related settings (e.g. speed of serial connection). This decreases the user-friendliness of the mobile device and increases the time for troubleshooting due to incompatible connection settings. Although some systems allow determination of the connection type via a hardware identification pin, the physical dedication of a hardware pin, however, increases the number of hardware pins in the docking connector of a PDA.

To allow users to perform a hassle-free synchronization without increasing the number of hardware pins in the docking connector, a method of differentiating between connection types is needed.

### SUMMARY OF THE INVENTION

The present invention eliminates unnecessary navigation and dedication of hardware pins as described earlier. The present invention allows users to experience a “dock and sync” experience by distinguishing a connection type from other connection types, such as a serial connection and a USB connection.

In one aspect, the present invention provides a method of differentiating connection types between two devices. In one embodiment, the present invention is used to differentiate between serial and USB connection types for connection between a desktop computer and a portable device such as a PDA.

When a portable device (or PDA) is connected to a computer system such as a desktop computer, serial line buffer is powered up. The presence or absence of a Clear To Send (CTS) signal is checked. If the connection type provided by the computer system to the PDA is serial, a CTS signal is asserted. Otherwise, CTS signal would not be asserted. According to the presence or absence of CTS signal, the connection type is differentiated. If the newly determined connection is serial, the presence of current or saved serial settings is checked. If there are the previous serial speed is used if the current connection is also serial. Serial speed settings will be saved if the current connection type is non-serial. Activation of the connector for synchronizing data follows immediately.

In a second aspect, the present invention provides a computer-readable medium containing program instructions for differentiating connection types as described above and for determining corresponding settings.

### BRIEF DESCRIPTION OF THE DRAWINGS

FIG. 1 illustrates one embodiment of a personal digital assistant (PDA).

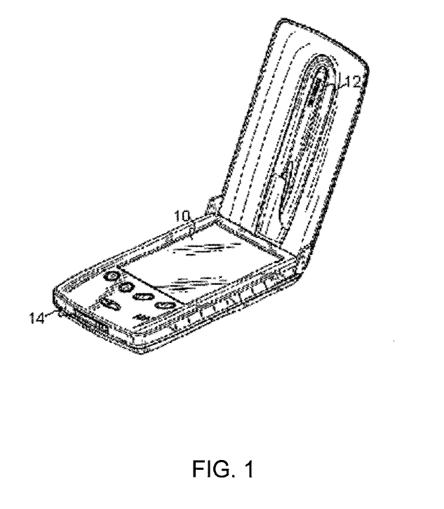

FIG. 2 is a flow diagram of the present invention.

FIG. 3 is a flow diagram of the present invention after the connection type is determined to be serial.

FIG. 4 is a flow diagram of the present invention after the connection type is determined to be USB.

### DETAILED DESCRIPTION OF THE INVENTION

A PDA includes any mobile device for electronic computation and/or personal information management, e.g., handheld personal computers (H/PCs), pocket PCs, personal organizers, palmtop computers and palm-size PCs. PDA may also be included as a secondary function in a product designed for other purpose. One example is to include functions typically performed by a PDA in a telecommunications device such as a cellular phone. Although a PDA is illustrated, the invention may be applied in other portable devices in which data synchronization, swapping and transferring functions are embodied. Hereinafter, “portable device” and “PDA” will be used to refer to such equivalents.

A PDA can be connected to one of a number of programmable digital computer systems and/or peripherals for different purposes, as exemplified follows. A PDA can be connected to a desktop or notebook computer for synchronizing data, printers for printing or a keyboard for convenient user input. Corresponding to the external device connected, the process ensuing the present invention may be synchronization, file swapping and data transfer, and the like.

A PDA can be connected to these systems by one of a plurality of communications links and protocols, depending on the capability of the PDA and the prospective system to which the PDA is to be connected. They can connect via physical links, such as cables, cradles and docking stations. In one aspect of the invention, a PDA can be docked in a cradle by engaging the docking connector embedded at one side of the PDA to a designated recess on the cradle. The cradle contains an external connection and a connector end that can be inserted into a compatible port at a desktop computer. A PDA can also connect to other systems via wireless links, such as infrared. The communications protocol subsequently used corresponds to the connection between the PDA and the computer system, which includes serial communication, network communication, infrared communication, wireless modem and wireless cellular digital packet data (CDPD) communication.

A person skilled in the art will appreciate that a desktop computer may be replaced by equivalent programmable digital computer systems operating in a standalone or network environment. Peripherals may include input devices such as keyboards, pointing devices, joystick, modem, scanners and the like; and output devices such as monitors, printers, speakers and the like.

In the following paragraphs, the present invention is described with respect to an embodiment in which a PDA is directly connected to a desktop via a physical connector.

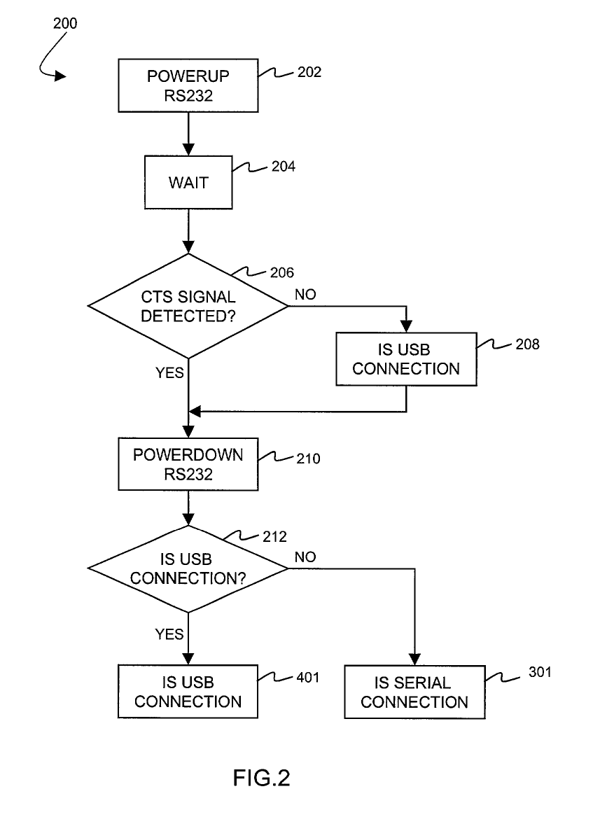

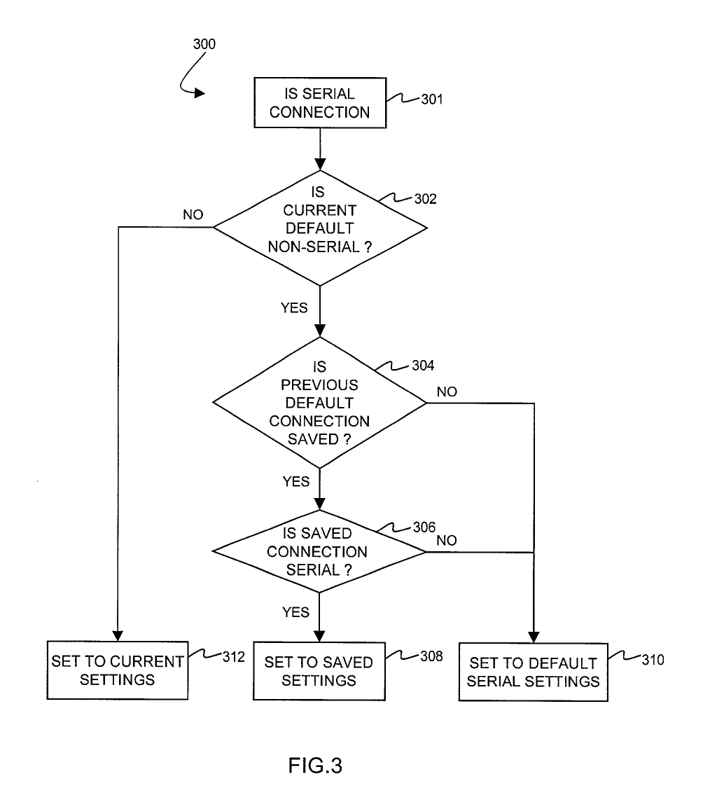

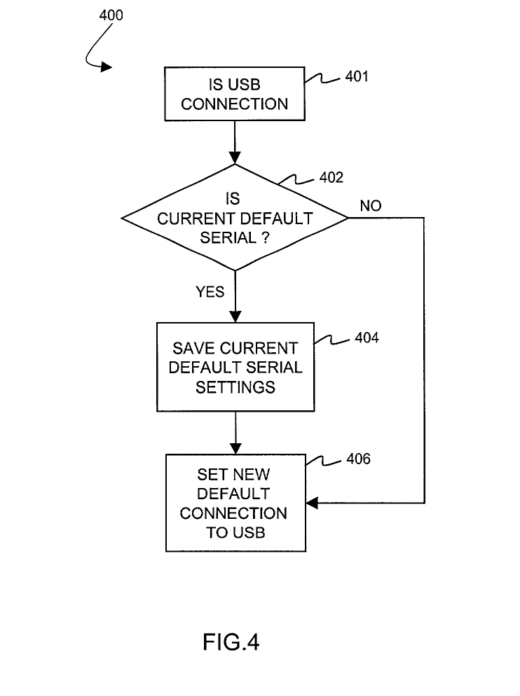

When a user decides to perform synchronization, he first uses a compatible physical connector to connect a PDA directly to a desktop computer. When the connection between the PDA and the desktop computer is complete, the program instructions in this invention will be executed (described later) as sequence 200 in FIG. 2 to determine the connection type that the user has employed. When the connection type is determined, either the sequence 300 in FIG. 3 or the sequence 400 in FIG. 4 will be executed (described later). The sequences 200, 300, 400 as described in FIG. 2, FIG. 3 and FIG. 4 respectively are transparent to the user. At the end of the sequence 300 or 400, the PDA will perform synchronization with the desktop computer and notify the user in a usual manner known to those skilled in the art.

Reference is made to FIG. 2. The sequence 200 begins in a POWERUP RS232 step 202. The processing unit enters this sequence 200 when a connection to an external device, i.e. desktop computer, is detected. In the POWERUP RS232 step 202, a serial line buffer (not shown) is supplied with power.

The sequence 200 then proceeds to a WAIT step 204. The processing unit waits for a specific period of time (in the order of milliseconds) so that the serial line buffer may properly receive power supply and generate appropriate signals.

After the WAIT step 204, the sequence 200 proceeds to a CTS SIGNAL DETECTED? decision step 206, where the processing unit detects the presence or absence of a Clear to Send (CTS) signal. A CTS signal is a RS-232 signal sent from a receiving device to a transmitting device indicating that it is clear to send data. CTS signal is asserted by the receiving device. When asserted, it indicates that the receiving device is ready to accept serial data. When unasserted, it indicates that data transmission should be disabled.

If the presence of a CTS signal is detected, the sequence 200 proceeds to a POWERDOWN step 210a where power is withdrawn from the serial line buffer. The connection type is determined to be serial and the sequence then proceeds to a IS SERIAL CONNECTION step 301 in sequence 300.

If the absence of a CTS signal is detected, the sequence 200 proceeds to a IS IT 5V? decision step 208. A USB connection typically draws a 5-Volt power while a serial connection typically draws a 12-Volt power. If a 5-Volt power is detected, the sequence 200 proceeds to a POWERDOWN step 210b where power is withdrawn from the serial line buffer. The connection type is determined to be USB and the sequence 200 then proceeds to a IS USB CONNECTION step 401 in sequence 400.

Reference is now made to FIG. 3. The sequence 300 in FIG. 3 illustrates the steps taken by the processing unit after determining the connection type to be serial. The sequence 300 begins with a IS SERIAL CONNECTION step 301.

The sequence 300 next proceeds to a IS CURRENT DEFAULT NON-SERIAL? decision step 302. Current default refers to the most recent connection type with which synchronization took place. The processing unit retrieves the current default connection type stored in memory 204 and checks if it is non serial. If the current default connection is serial, the sequence proceeds to a SET TO CURRENT SETTINGS step 312. In the SET TO CURRENT SETTINGS step 312, the most recent settings are retained and used in the ensuing synchronization process. If the current default is non-serial, the processing unit checks in the memory 204 for the presence of a saved previous default connection prior to the current default in a IS PREVIOUS DEFAULT CONNECTION SAVED? decision step 304.

If the processing unit does not detect the presence of a saved previous default connection, the sequence 300 proceeds to a SET TO DEFAULT SERIAL SETTINGS step 310 where the serial speed setting is set to a predetermined value. If the processing unit detects the presence of a saved previous default connection, the sequence then proceeds to a IS SAVED CONNECTION SERIAL? decision step 306.

In the IS SAVED CONNECTION SERIAL? decision step 306, the processing unit checks whether the saved settings pertain to a serial connection. If the saved connection is serial, the sequence 300 proceeds to a SET TO SAVED SETTINGS step 308 where the saved serial speed settings are used in the ensuing synchronization process. If the saved connection is non serial, the sequence 300 proceeds to a SET TO DEFAULT SERIAL SETTINGS step 310 where the serial speed setting is set to a predetermined value.

Reference is now made to FIG. 4. The sequence 400 in FIG. 4 illustrates the steps taken by the processing unit after determining the connection type to be USB. The sequence 400 begins with a IS USB CONNECTION step 301.

The sequence 400 next proceeds to a IS CURRENT DEFAULT SERIAL? decision step 402. Current default refers to the most recent connection type with which synchronization took place. The processing unit checks if the current default connection is serial. If it is, the sequence 400 proceeds to a SAVE CURRENT DEFAULT SERIAL SETTINGS step 404 to store the serial settings in memory 204. The sequence 400 then proceeds to a SET NEW DEFAULT CONNECTION TO USB step 406 to assign USB as the connection type for the ensuing synchronization process. If the current default is not serial, the sequence 400 next proceeds to a SET NEW DEFAULT CONNECTION TO USB step 406.

From the foregoing analysis, the present invention provides a computer-based method for determination of connection type. Although the invention has been described using one embodiment containing a Personal Digital Assistant (PDA) and a desktop computer, it is not to be so limited. A person skilled in the art will recognize that changes may be made in form and detail without departing from the spirit and scope of the invention.

We claim:

1. A computer-based method for auto-determining a connection type between two devices, comprising the steps of:
connecting a first device to a second device, wherein the first device is a portable device and the second device is a programmable digital computer system or a computer peripheral device;
ascertaining an existence of an assertion signal of a particular type; and
determining the connection type by a presence or absence of the assertion signal.

2. The computer-based method recited in claim 1 wherein
after connecting the first device to the second device, supplying power to the connection between the first device and the second device via the first device or the second device.

3. The computer-based method recited in claim 1 wherein
ascertaining the existence of an assertion signal of a particular type includes ascertaining the existence of a Clear-To-Send signal or a five-Volt power signal.

4. The computer-based method recited in claim 3 wherein
after determining the connection type as USB, designating the connection type as USB; and
saving any existing serial settings.

5. The computer-based method recited in claim 3 wherein
after determining the connection type as serial, designating the connection type as serial;
ascertaining an existence of saved serial settings; and
using such serial settings if available.

6. The computer-based method recited in claim 1 wherein
after determining the connection type, designating the connection type as serial;
ascertaining an existence of saved serial settings; and
using such serial settings if available.

7. The computer-based method recited in claim 1 wherein
after determining the connection type, designating the connection type as USB; and
saving any existing serial settings.

8. A computer-readable media containing program instructions for executing by a computing device to auto-determine a connection type comprising:
means for connecting a first device to a second device, wherein the first device is a portable device and the second device is a programmable digital computer system or a computer peripheral device;
means for detecting an assertion signal of a particular type such as a Clear-To-Send and a five-Volt power signal; and
means for interpreting the assertion signal to determine connection type.

9. The apparatus recited in claim 8 further comprising:
means for supplying power to the connection between the first device and the second device via the first device or the second device.

10. The apparatus recited in claim 8 further comprising:
means for assigning the connection type;
means for ascertaining an existence of settings associated with the assigned connection type; and
means for using such settings if available.

11. The apparatus recited in claim 8 further comprising:
means for assigning the connection type as USB and means for saving existing serial settings.

12. The apparatus recited in claim 8 further comprising:
means for assigning the connection type as serial;
means for ascertaining an existence of saved serial settings; and
means for using such settings if available.

13. A computer-readable media containing program instructions for executing by a computing device to perform the method of auto-determining connection type, the method comprising:
connecting a first device to a second device, wherein the first device is a portable device and the second device is a programmable digital computer system or a computer peripheral device;
detecting an assertion signal of a particular type from one of Clear-To-Send and five Volt; and
interpreting the assertion signal to determine connection type.

14. The computer-readable media recited in claim 13 further comprising
after connecting the first device to the second device, supplying power to the connection between the first device and the second device via the first device or the second device.

15. The computer-readable media recited in claim 13 wherein
ascertaining an existence of an assertion signal of a particular type includes ascertaining an existence of a Clear-To-Send signal or a five-Volt power signal.

16. The computer-readable media recited in claim 15 wherein
after determining the connection type as USB, designating the connection type as USB; and
saving any existing serial settings.

17. The computer-readable media recited in claim 15 wherein
after determining the connection type as serial, designating the connection type as serial;
ascertaining an existence of saved serial settings; and
using such serial settings if available.

18. The computer-readable media recited in claim 13 wherein
after determining the connection type, designating connection type as serial;
ascertaining an existence of saved serial settings; and
using such serial settings if available.

19. The computer-based method recited in claim 13 wherein
after determining the connection type, designating the connection type as USB; and
saving any existing serial settings.
